(19) United States
(12) Patent Application Publication
(10) Pub. No.: US 2007/0284297 A1
(43) Pub. Date: Dec. 13, 2007

(54) APPARATUS FOR THE PURIFICATION OF ORGANIC MOLECULES AND RELEVANT METHOD OF MANUFACTURE

(76) Inventor: Marcello Gatti, Vignola (MO) (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/696,973

(22) Filed: Apr. 5, 2007

(30) Foreign Application Priority Data
Jun. 9, 2006 (IT) MO2006A000182

(51) Int. Cl. C08J 5/22; B01D 29/56

(52) U.S. Cl. 210/255; 210/486; 521/27

(57) ABSTRACT

The apparatus for the purification of organic molecules, comprising a hollow body of substantially elongated shape, open at the ends and internally defining at least one transit duct for a fluid mix, at least one functionalised permeable support housed inside the duct and having a basic permeable material to which is associated at least one chemical agent suitable for trapping, during the transit of the mix, at least one organic molecule to be purified, characterized in that the chemical agent is associated with the basic permeable material by chemical reaction between a first functional group on the molecular structure of the chemical agent and a second functional group on at least one between the molecular structure of the basic permeable material and the molecular structure of a binder associable with the basic permeable material, the first functional group and the second functional group being selected between an aminic functional group, a carboxylic functional group, a succinimidic functional group, a thiolic functional group or a maleimidic functional group.

The present invention relates to an apparatus for the purification of organic molecules and relevant method of manufacture.

The use is known of purification systems for organic molecules such as mycotoxins, antibiotics, vitamins, pesticides, etc.

The known systems are generally based on the principle of purification of immunoaffinities or on the principle of purification by chemical-physical affinities, whereby the organic molecule to be analysed is separated from the base mix of which it is part by immunoaffinity, chemical and/or physical affinity with the system, the chemical-physical characteristics of which are fixed a priori.

The chemical-physical characteristics used for the separation are, inter alia, the following: ionic exchange, steric or weight hindrance, pH, immunoaffinity, electric charge unbalance, electrostatic separation.

Generally speaking, the purification systems available on the market are in the form of apparatus, commonly known as “columns” or “small columns”.

Such apparatuses generally have an outer case of polymeric material, substantially cylindrical, open at the ends, and internally defining a transit duct for the base mix containing, inter alia, the organic molecules to be purified.

Inside the duct, a substantially solid and permeable support is fixed to which are bound agents such as antibodies or the like suitable for trapping organic molecules during base mix transit.

The organic molecules are therefore trapped inside the support, binding themselves to this, and are subsequently released following subsequent introduction, inside the duct, of a fluid suitable for detaching from the support the molecules trapped on it. This sequence of operations permits collecting, downstream of the apparatus, the purified organic molecules for subsequent analytic phases.

These known apparatuses have a number of drawbacks, in particular, the columns used are generally disposable, i.e., they are only able to perform just one purification process due to the total or partial drop in binding capacity between the support and the molecules to be purified or to other causes of a chemical or physical nature.

The main aim of the present invention is to provide an apparatus for the purification of organic molecules that can be reused to perform several successive purification processes.

Within the sphere of this technical aim, another object of this invention is to cater for the above aims with a simple structure, of relatively practical implementation, safe to use and with effective operation, as well as having a relatively low cost.

The above objects are all achieved by the present apparatus for the purification of organic molecules, comprising a hollow body of substantially elongated shape, open at the ends and internally defining at least one transit duct for a fluid mix, at least one functionalised permeable support housed inside said duct and having a basic permeable material to which is associated at least one chemical agent suitable for trapping, during the transit of said mix, at least one organic molecule to be purified, characterized in that said chemical agent is associated with said basic permeable material by chemical reaction between a first functional group on the molecular structure of said chemical agent and a second functional group on at least one between the molecular structure of said basic permeable material and the molecular structure of a binder associable with said basic permeable material, said first functional group and said second functional group being selected between an aminic functional group, a carboxylic functional group, a succinimidic functional group, a thiolic functional group or a maleimidic functional group.

Further characteristics and advantages of the present invention will appear even more evident from the detailed description of a preferred, but not exclusive, embodiment of an apparatus for the purification of organic molecules, illustrated indicatively by way of non limiting example, in the attached drawings wherein:

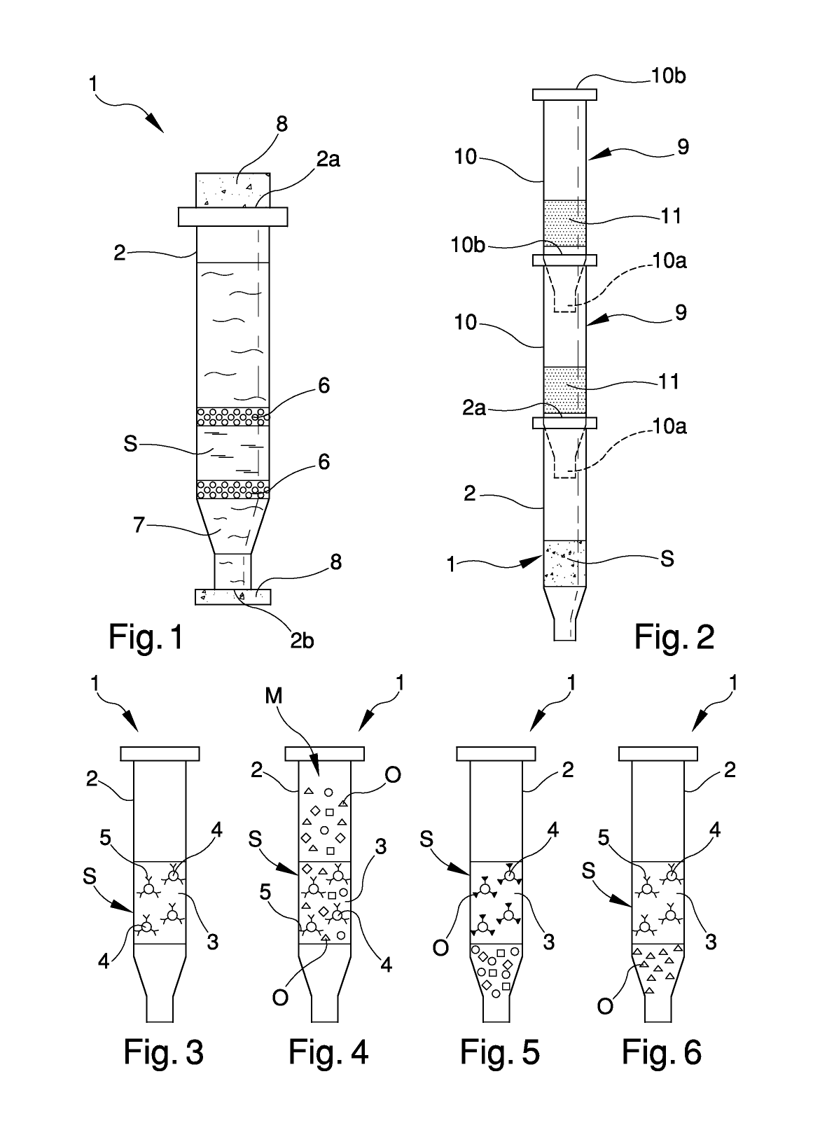

FIG. 1 is a schematic and side view of the apparatus according to the invention;

FIG. 2 is a view of the apparatus according to the invention to which is fitted a pair of pre-purification supplementary apparatuses;

FIGS. 3, 4, 5 and 6 illustrate four distinct phases of the purification process of an organic molecule by means of the apparatus according to the invention.

With special reference to such figures, an apparatus for the purification of a sample of organic molecules O has been globally designated by reference number 1.

The apparatus 1 is of the so-called “column” type, and can be used, for example, for the purification of organic molecules O before carrying out specific laboratory analyses or tests.

The apparatus 1 comprises a hollow body 2, of substantially elongated shape and open at the ends, which internally defines a transit duct for a fluid mix M.

In particular, the hollow body 2 has a substantially cylindrical shape and has, at one end, an inflow first opening 2a for the inflow of the M mix and, at the opposite end, an outflow second opening 2b.

The hollow body 2 can be made of polymeric type material and can have a capacity between 0.1 ml and 10,000 ml.

Furthermore, different shapes of the hollow body 2 cannot be ruled out with different number or arrangement of the first and/or of the second openings 2a and 2b.

The apparatus 1 comprises a functionalised permeable support S housed inside the duct of the hollow body 2.

The functionalised permeable support S in its definitive shape is made up of a basic permeable material 3 to the surface of which is bound a chemical agent 5 suitable for trapping the organic molecules O to be purified, during transit of the mix M.

Usefully, a binder 4 can be placed in between the basic permeable material 3 and the chemical agent 5. The presence of the binder 4 can ensure more stable binding or, in any case, a mediated reaction more efficient and chemically and kinematically favoured compared to a direct reaction between the basic permeable material 3 and the chemical agent 5.

In particular, the chemical agent 5 is associated with the basic permeable material 3 by chemical reaction between a first functional group on the molecular structure of the chemical agent 5 and a second functional group on the molecular structure of the basic permeable material 3 or on the molecular structure of the binder 4 associated with the basic permeable material 3.

Alternatively, the binder 4 can be associated with the basic permeable material 3 following the reaction with the chemical agent 5.

Advantageously, the first functional group and the second functional group are selected from the whole comprising: an aminic functional group, a carboxylic functional group, a succinimidic functional group, a thiolic functional group or a maleimidic functional group.

In particular, in a first embodiment of the invention, the chemical agent 5 is associated with the binder 4 or directly with the basic permeable material 3 by chemical reaction between the first functional group, composed of an aminic functional group, and the second functional group, composed of a succinimidic functional group or of a carboxylic functional group.

In a second embodiment of the invention, the chemical agent 5 is associated with the binder 4 or directly with the basic permeable material 3 by chemical reaction between the first functional group, composed of a carboxylic functional group or a succinimidic functional group, and the second functional group, composed of an aminic functional group.

In a third embodiment of the invention, the chemical agent 5 is associated with the binder 4 or directly with the basic permeable material 3 by chemical reaction between the first functional group, composed of a thiolic functional group, and the second functional group, composed of a maleimidic functional group.

In a fourth embodiment of the invention, the chemical agent 5 is associated with the binder 4 or directly with the basic permeable material 3 by chemical reaction between the first functional group, composed of a maleimidic functional group, and the second functional group, composed of a thiolic functional group.

In detail and for the purposes of the present invention, the functional groups described above are intended of the type of: an aminic functional group characterizing the class of compounds of the primary secondary and tertiary amines and of general formula—NH₂, —NHR or —NRR′; a carboxylic functional group characterizing the class of compounds of the carboxylic acids and of general formula —COOH; a thiolic functional group characterizing the class of compounds of the mercaptans and of general formula —SH; an imidic functional group composed of two acyl groups bound to an atom of nitrogen such as that characterizing the class of compounds of the imides (e.g., the succinimide and the maleimide, herein also called succinimidic/s and meleimidic/s).

Usefully, in the event of the binder 4 being used, the chemical reactions between the first and the second functional group described above are the same used to bind the binder 4 to the basic permeable material 3 to complete the functionalised permeable support S.

The basic permeable material 3 is of the type of a porous material in the substantially solid state and can comprise agarose, in particular modified agarose (of the Sepharose™ or Sepharose™ Fast Flow type or the like) or, alternatively, it can comprise a metal, a semi-metal, a metal oxide, a protein or a peptide or a mix of these however compounded.

In detail, the molecular structure of the binder 4 can be composed in its definitive form (i.e., after the reactions described above) by a single atom of carbon, sulphur or nitrogen or, alternatively, it can be composed of a chain of linear carbon atoms, branched, saturated, monounsaturated or polyunsaturated, including substituted by hetero-atoms.

Advantageously, the succinimidic functional groups used in the first and in the second embodiment of the invention can be of the type present in the succinimidyl esters such as, for example, N-hydroxysuccinimide (NHS) ester, etc.

The chemical agent 5 suitable for trapping the organic molecules O can be made up of an antibody, an enzyme, a protein, a natural or synthetic peptide, a nucleotide or a chain of nucleotides.

In general, the chemical agent 5 has in any case at least one aminic functional group (primary, secondary or tertiary), carboxylic, thiolic, maleimidic or succinimidic suitable for reacting with at least one among the functional groups of the binder 4 or of the basic permeable support 3 and a further reactive site or functional group able to bind to the organic molecules O to be purified or with which to interact.

In general, the molecules of the chemical agent 5 are able to bind with other molecules in certain chemical-physical conditions; more specifically, such chemical-physical conditions are determined simultaneously by the type of organic molecule O to be purified and by the chemical agent 5 itself.

Advantageously, the organic substances O that can be selectively trapped by the chemical agent 5, and which are therefore purifiable by means of the apparatus 1, comprise the molecules belonging to the following categories:

mycotoxins such as, for example, alpha toxin (B1, B2, G1, G2, M1 and M2), zearalenone, fumosine (B1 and B2), trichothecines, deoxynivalenol, ochratoxin A, toxin T2, toxin HT2, and other toxins;

antibiotics such as, for example, gentamicin, tylosin, streptomycin, dehydrostreptomycin, Chloramphenicol and other antibiotics;

vitamins (B1, B2, B3, M, H, B12 and other vitamins);

anabolic steroids;

steroids;

beta-agonists;

proteins such as (casein, beta-lactoglobulin, ovoalbumin, gluten and other proteins).

Usefully, the apparatus 1 comprises blocking means 6 for blocking the functionalised permeable support S inside the duct of the hollow body 2.

In particular, the blocking means 6 are composed of two porous membranes fitted to measure inside such duct at two opposite surfaces of the functionalised permeable support S.

The porous membranes 6 can have a porosity between 0.45 microns and 500 microns. Before being used for the purification of an organic molecule O, the hollow body 2 contains a stabilizing fluid 7 suitable for maintaining suitable chemical conditions inside the duct, and the first and the second openings 2a and 2b are hermetically closed by means of seal closing devices 8, of the cap type or the like.

Advantageously, upstream of the apparatus 1, a supplementary apparatus 9 can be fitted for pre-purifying the mix M.

In particular, the supplementary apparatus 9 comprises an outer case 10 of substantially tubular shape, suitable for the transit of the mix M and having at least one first end 10a open and associable by interlocking at the first opening 2a of the hollow body 2 and a second end 10b open and suitable for introducing the mix M.

Inside the case 10 is housed a permeable element 11 suitable for being crossed by the mix M and which supports anti-oxidative, antibiotic substances, etc.

The permeable element 11 is made using materials such as agarose, in particular agarose gel (of the Sepharose™ or Sepharose™ Fast Flow type), a metal, a semi-metal, a metal oxide, silica or alumina.

Usefully, the supplementary apparatus 9 comprises retention means for retaining the permeable element 11 inside the case 10.

In particular, the retention means are composed of two porous membranes fitted to measure inside such case 10 at two opposite surfaces of the permeable element 11. Such porous membranes can have a porosity between 0.45 microns and 1000 microns. Before the supplementary apparatus 9 is used for the pre-purification of the mix M, the case 10 contains a stabilizing fluid suitable for maintaining suitable chemical conditions, and is closed hermetically by means of seal closing devices, of the cap type or the like.

Advantageously, as shown in FIG. 2, two supplementary apparatuses 8 can be associated together in series (by interlocking the first end 10a of one of these in the second end 10b of the other) and fitted upstream of the apparatus 1 for the execution of a further and possibly different phase of pre-purification of the mix M.

With particular but not exclusive reference to the first embodiment of the invention described above, the method for manufacturing the device 1 comprises a preliminary sample phase of a predefined quantity (e.g., 1 g) of basic permeable material 3 having, for example, carboxylic functional groups on the surface.

The subsequent activation of the surface of the basic permeable material consists in adding a predefined quantity (e.g., 2 ml) of a solution comprising 0.5 M of N-ethyl-N′-dimethylaminopropyl-carbodiimide (EDC) for 0.1 M of N-hydroxysuccinimide (NHS), in mixing, and in leaving the solution in contact with the basic permeable material 3 for at least 2 hours in adequate pH conditions (e.g., pH 7.4).

The basic permeable material 3 thus activated is then centrifuged and washed to eliminate the supernatant.

The method then comprises a phase that consists in introducing a predetermined quantity of chemical agent 5 ( in this case functionalised with aminic groups) and in leaving it in contact with the binder 4 for at least 2 hours at a suitable temperature (e.g., 25° C.).

This way there is a binding chemical reaction between the aminic functional groups of the chemical agent 5 and the succinimidic functional groups that allows manufacturing the functionalised permeable support S.

Following a further washing phase and any modification of the pH, a predefined quantity of functionalised permeable support S is introduced inside the duct of the hollow body 2.

Alternatively, to prepare the functionalised permeable support S, a basic permeable material 3 can be used, of the type described above, already having the succinimmidic groups or, in any case, already having bound succinimmidic functional groups by interposition of a binder 4.

The subsequent preparation phases are performed in the same way described above after possible acidification with diluted strong acid and subsequent correction of the pH to bring this to the reaction conditions (e.g., pH 7.4). The chemical agent 5, suitable for entrapment, is then added, having at least one aminic functional group and is left to react for about 2 hours at room temperature. The whole is washed, if necessary with organic solvents, and the functionalised permeable support S thus obtained is then inserted inside the hollow body 2 as described above.

The operation of the apparatus 1 is as follows.

A preliminary phase involves the removal of the caps 8 from the first and from the second openings 2a and 2b, and the emptying of the stabilizing fluid 7 from the duct of the hollow body 2.

The apparatus 1 prepared in this way, shown in FIG. 3, can be used to execute the process of purification of the organic molecule O.

As shown in FIG. 4, the mix M comprising the organic molecules O to be purified is introduced inside the hollow body 2 through the first opening 2a and moves towards the second opening 2b through the porosities of the functionalised permeable support S.

As shown in FIG. 5, upon the transit of the mix M the chemical agent 5, which is fixed to the functionalised permeable support S, interacts with the organic molecules O and traps these.

The mix M thus deprived of the organic molecules O comes out of the second opening 2b.

A last phase, shown in FIG. 6, involves the introduction through the first opening 2a of a fluid suitable for detaching the organic molecules O trapped by the chemical agent 5, subsequently collected downstream of the apparatus 1.

Following such purification process, the apparatus 1 can be used again for further processes, in the same way as has been described above, or, alternatively, it can be filled again by means of the stabilizing fluid 7 and hermetically closed by means of the caps 8 for subsequent reuses.

In case of use of one or more supplementary apparatuses 9 the process is repeated in the same way as described above, with the execution of additional pre-purification processes upon transit of the mix M inside the cases 10, at the permeable elements 11. The supplementary apparatuses 9 and 10, unlike the apparatus 1, are generally of the disposable type.

It has in fact been ascertained how the described invention achieves the set objects, and in particular the fact is underlined that the apparatus permits the execution of more than one organic substance purification process.

The possibility of reusing the apparatus further permits considerably cutting the general costs of execution of the purification processes, compared to the traditional processes performed using the known disposable apparatus.

The invention thus conceived is susceptible of numerous modifications and variations, all of which falling within the scope of the inventive concept.

Furthermore all the details may be replaced by other elements which are technically equivalent.

In practice, the contingent shapes and dimensions may be any according to requirements without because of this moving outside the protection scope of the following claims.

1. Apparatus for the purification of organic molecules, comprising a hollow body of substantially elongated shape, open at ends thereof and internally defining at least one transit duct for a fluid mix, at least one functionalised permeable support housed inside said duct and having a basic permeable material to which is associated at least one chemical agent suitable for trapping, during the transit of said mix, at least one organic molecule to be purified, said chemical agent is associated with said basic permeable material by chemical reaction between a first functional group on the molecular structure of said chemical agent and a second functional group on at least one between the molecular structure of said basic permeable material and the molecular structure of a binder associable with said basic material, said first functional group and said second functional group being selected from the group consisting of an aminic functional group, a carboxylic functional group, a succinimidic functional group, a thiolic functional group and a maleimidic functional group.

2. Apparatus according to claim 1, wherein said first functional group comprises at least one aminic functional group and said second functional group comprises at least one between a succinimidic functional group or a carboxylic functional group.

3. Apparatus according to claim 1, wherein said first functional group comprises at least one between a carboxylic functional group and a succinimidic functional group and said second functional group comprises at least one aminic functional group.

4. Apparatus according to claim 1, wherein said first functional group comprises at least one thiolic functional group and said second functional group comprises at least one maleimidic functional group.

5. Apparatus according to claim 1, wherein said first functional group comprises at least one maleimidic functional group and said second functional group comprises at least one thiolic functional group.

6. Apparatus according to claim 1, wherein said succinimidic functional group is of the type present in an N-hydroxysuccinimide (NHS) ester or other similar compounds.

7. Apparatus according to claim 1, wherein said chemical agent is selected from the group consisting of antibodies, enzymes, proteins, peptides, amino acids and oligonucleotides.

8. Apparatus according to claim 1, wherein said basic permeable material is of the type of a substantially solid porous material.

9. Apparatus according to claim 1, wherein said basic permeable material is selected from the group consisting of agarose, metals, semi-metals or metal oxides, proteins or peptides.

10. Apparatus according to claim 1, wherein said basic permeable material comprises modified agarose gel.

11. Apparatus according to claim 1, wherein said hollow body comprises at least one inflow first opening of said mix.

12. Apparatus according to claim 1, wherein said hollow body comprises at least one outflow second opening of said mix deprived of said trapped organic molecules.

13. Apparatus according to claim 1, wherein said hollow body has a substantially cylindrical shape.

14. Apparatus according to claim 1, wherein said hollow body is made of polymeric material.

15. Apparatus according to claim 1, comprising blocking means for blocking said basic permeable material inside said duct.

16. Apparatus according to claim 15, wherein said blocking means comprise at least one porous membrane fitted to measure inside said duct near said basic permeable material.

17. Apparatus according to claim 16, wherein said blocking means comprise at least two of said porous membranes fitted inside said duct at opposite surfaces of said basic permeable material.

18. Apparatus according to claim 1, wherein said hollow body contains a stabilizing fluid suitable for maintaining suitable chemical conditions inside said duct, before the transit of said fluid mix.

19. Apparatus according to claim 1, comprising seal closing devices for closing at least one between said first opening and said second opening.

20. Apparatus according to claim 1, wherein said seal closing devices are of the cap type.

21. Apparatus according to claim 1, wherein said organic molecules are of the mycotoxins, antibiotics, vitamins, anabolic steroids, steroids, beta-agonists type.

22. Apparatus according to claim 1, wherein it is associable with at least one supplementary apparatus for pre-purifying said mix.

23. Apparatus according to claim 22, wherein said supplementary apparatus comprises a substantially tubular case, suitable for the transit of said fluid mix, and having at least one end associable with said first opening.

24. Apparatus according to claim 23, wherein said supplementary apparatus comprises at least one permeable element housed inside said tubular element and supporting anti-oxidative, antibiotic substances.

25. Apparatus according to claim 22, wherein a plurality of said supplementary apparatuses are functionally associable in series with each other, upstream of said hollow body.

26. Apparatus according to claim 1, wherein the molecular structure of said binder comprises at least one between a single atom of carbon, sulphur or nitrogen, or a chain of linear carbon atoms, branched, saturated, monounsaturated or polyunsaturated, including substituted by hetero-atoms.

27. Method for manufacturing an apparatus for the purification of organic molecules, comprising supplying a predefined quantity of a basic permeable material and associating a chemical agent suitable for trapping at least one type of organic molecules with said basic permeable material for manufacturing a functionalised permeable support, wherein said associating comprises a chemical reaction between a first functional group on the molecular structure of said chemical agent and a second functional group on at least one between the molecular structure of said basic permeable material and the molecular structure of a binder associable with said basic permeable material, said first functional group and said second functional group being selected from the group consisting of an aminic functional group, a carboxylic functional group, a succinimidic functional group, a thiolic functional group or a maleimidic functional group.

28. Method according to claim 27, wherein said first functional group comprises at least one aminic functional group and said second functional group comprises at least one between a succinimidic functional group or a carboxylic functional group.

29. Method according to claim 27, wherein said first functional group comprises at least one between a carboxylic functional group and a succinimidic functional group and said second functional group comprises at least one aminic functional group.

30. Method according to claim 27, wherein said first functional group comprises at least one thiolic functional group and said second functional group comprises at least one maleimidic functional group.

31. Method according to claim 27, wherein said first functional group comprises at least one maleimidic functional group and said second functional group comprises at least one thiolic functional group.

32. Method according to claim 27, wherein said supplying comprises sampling a predefined quantity of said basic permeable material and activating the surface of said basic permeable material.

33. Method according to claim 32, wherein said activating comprises adding a solution comprising a predefined quantity of N-ethyl-N″-dimethylaminopropyl-carbodiimide (EDC) and a predefined quantity of N-hydroxysuccinimide (NHS) or the like.

34. Method according to claim 27, comprising centrifuging said basic permeable material.

35. Method according to claim 27, comprising centrifuging said basic permeable material having said binder.

36. Method according to claim 27, comprising a leaving said chemical agent in contact with said binder for a predefined time.

37. Method according to claim 27, comprising leaving said chemical agent in contact with said basic permeable material for a predefined time.

38. Method according to claim 27, comprising introducing a predefined quantity of said functionalised permeable support inside a hollow body of substantially elongated shape and open at the ends by at least one transit duct for a fluid mix.

39. Method according to claim 27, wherein said chemical agent is selected from the group consisting of antibodies, enzymes, proteins, peptides, amino acids and oligonucleotides.

40. Method according to claim 27, wherein said basic permeable material is of the type of a substantially solid porous material.

41. Method according to claim 27, wherein said basic permeable material is selected from the group consisting of agarose, metals, semi-metals or metal oxides, proteins and peptides.
